(19) United States
(12) Patent Application Publication
(10) Pub. No.: US 2003/0110900 A1
(43) Pub. Date: Jun. 19, 2003

(54) Gripping device for safely holding nails

(76) Inventor: Hsi Tang Chen, Taichung (TW)

Correspondence Address: Hsi Tang Chen, P.O. Box 63-99, Taichung, 406, TW

(21) Appl. No.: 10/015,555

(22) Filed: Dec. 17, 2001

(51) Int. Cl. B25C 3/00

(52) U.S. Cl. 81/44

(57) ABSTRACT

A gripping device for holding nails includes a rod having one or more slots formed in one end for forming two or more spring legs, and for clamping and grasping the nails with the spring legs, and for safely obtaining the nails without contacting the hands of the users with the nails, and for firmly holding the nails without forcing the gripping device all the time while gripping the nails, and for safely holding the nails while hammering the nails. A spring ring may force the spring legs to clasp the nail. A barrel may be threaded to force the spring legs to clamp the nail.

### BACKGROUND OF THE INVENTION

1. Field of the Invention

The present invention relates to a gripping device, and more particularly to a gripping device for safely holding or gripping or obtaining the nails without contacting the hands of the users with the nails.

2. Description of the Prior Art

Typically, the nails should be pick up manually. Some of the workers may grasp or grip or obtain the nails with the plier devices. However, the workers should tightly hold or force, all the time, the plier devices to solidly grasp the nails in the plier devices and for preventing the nails from being disengaged from the plier device. The nails may thus be easily disengaged from the plier device when the hand of the user has become loose. No gripping devices may be provided for easily and safely grasping or gripping the nails without directly engaging with the nails by the hands of the workers. In addition, the hands of the workers or of the users may be hurt by the nails inadvertently if the nails have been rusted. Furthermore, when holding the nails with the hand of the users and when hammering the nails, the hand of the users may also be easily hammered or hurt by the hammer.

The present invention has arisen to mitigate and/or obviate the afore-described disadvantages of the conventional gripping devices for nails.

### SUMMARY OF THE INVENTION

The primary objective of the present invention is to provide a gripping device for safely holding or gripping or obtaining the nails without contacting the hands of the users with the nails.

The other objective of the present invention is to provide a gripping device for firmly holding or gripping the nails without forcing the gripping device all the time while gripping the nails.

The further objective of the present invention is to provide a gripping device for safely holding the nails while hammering the nails.

In accordance with one aspect of the invention, there is provided a gripping device for holding nails, the gripping device comprising a rod including a first end having a first slot formed therein for forming a pair of spring legs in the first end of the rod, and for clamping and grasping the nail in the first slot of the rod and between the pair of spring legs. The gripping device may thus be used for safely holding or obtaining the nails without contacting the hands of the users with the nails, and for firmly holding or gripping the nails without forcing the gripping device all the time while gripping the nails, and for safely holding the nails while hammering the nails.

The rod includes at least one channel formed in the first end thereof and communicating with the first slot of the rod for receiving the nail.

The rod includes a second slot formed in the first end thereof and communicating and intersecting with the first slot of the rod for forming two pairs of spring legs in the first end of the rod, and for clamping and grasping the nail in either of the first slot or the second slot of the rod.

The rod includes at least one channel formed in the first end thereof and communicating with the second slot of the rod for receiving the nail.

A device is further provided for biasing the pair of spring legs to clamp the nail and includes a resilient ring engaged onto the pair of spring legs for biasing the pair of spring legs to clamp the nail. The rod includes a peripheral groove formed in the first end thereof for receiving the resilient ring.

A device is further provided for forcing the pair of spring legs to clamp the nail and includes a barrel threaded onto the pair of spring legs, the barrel includes a first end having a greater diameter and a second end having a smaller diameter for forcing the pair of spring legs toward each other to clamp the nail when the barrel is adjusted and threaded relative to the pair of spring legs.

A device is further provided for limiting the barrel to move relative to the rod and the spring legs and includes a peripheral shoulder formed in the rod for engaging with the barrel and for limiting the barrel to move relative to the rod and the spring legs.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a gripping device in accordance with the present invention;

FIG. 2 is an exploded view of the gripping device;

FIG. 3 is a cross sectional view taken along lines 3-3 of FIG. 1;

FIG. 4 is a schematic view illustrating the operation of the gripping device; and

FIGS. 5 and 6 are perspective views illustrating the operation of the gripping device.

### DETAILED DESCRIPTION OF THE PREFERRED EMBODIMENT

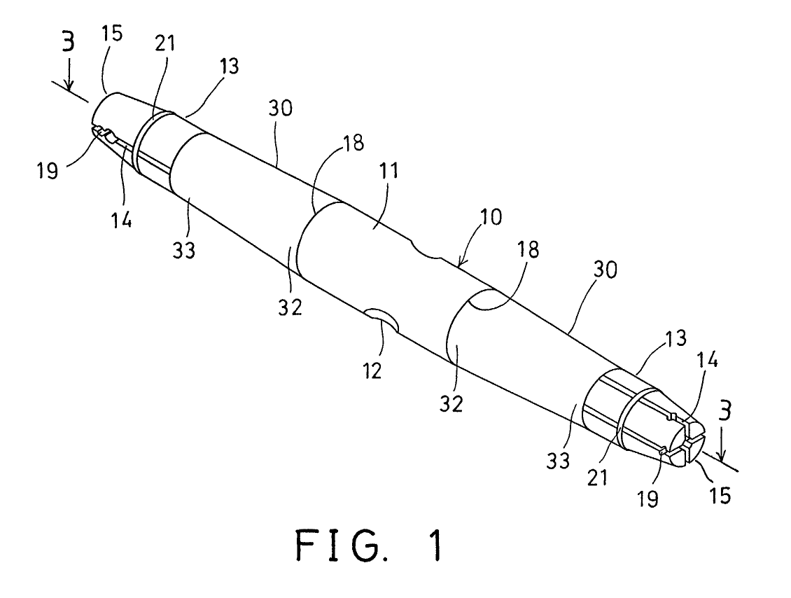

Referring to the drawings, and initially to FIGS. 1-4, a gripping device in accordance with the present invention is provided for safely holding or obtaining the nails without contacting the hands of the users with the nails, and for firmly holding or gripping the nails without forcing the gripping device all the time while gripping the nails, and for safely holding the nails while hammering the nails. The gripping device comprises a longitudinal rod body 10 including a middle portion 11 having an outer diameter greater than that of the end portions 13 thereof, for forming two peripheral shoulders 18 between the middle portion 11 and the end portions 13 respectively. The middle portion 11 of the rod 10 may be formed as a handle 11 for allowing the gripping device to be easily grasped or held by the users. The middle portion 11 of the rod 10 includes one or more depressions 12 formed therein for allowing the middle handle 11 of the rod 11 to be solidly held or grasped by the users.

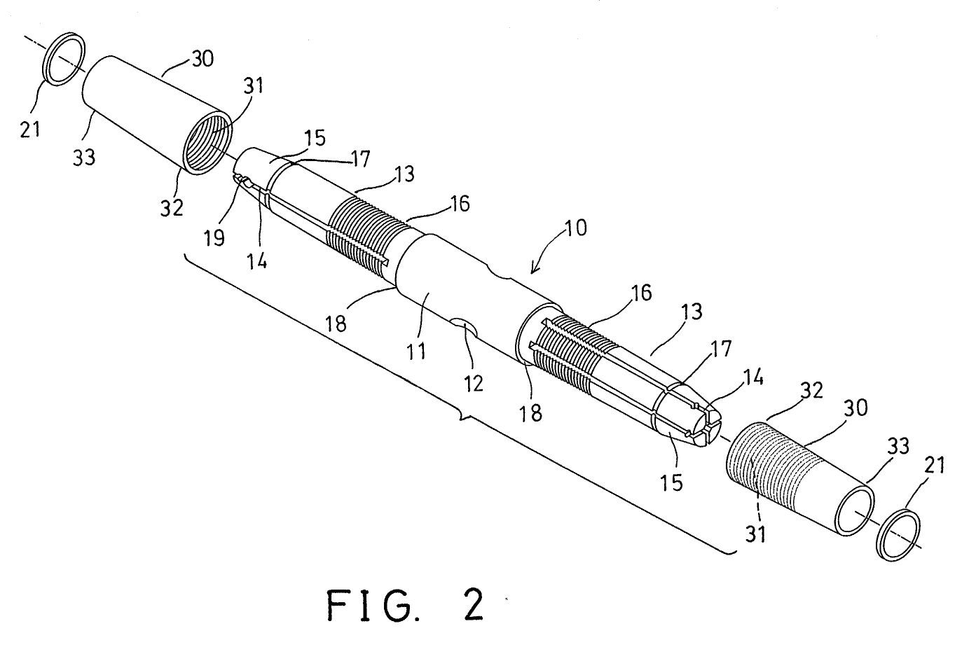

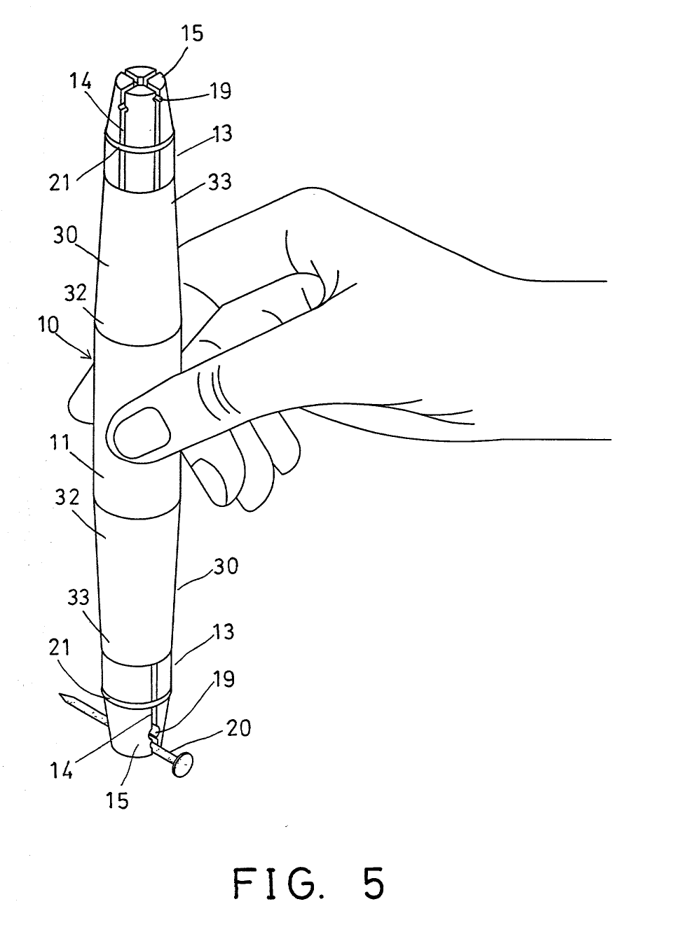

Either or both of the end portions 13 of the rod 10 each includes one or more longitudinal slots 14 formed therein. For example, as shown in the left portion of the rod 10 in FIG. 2, a single slot 14 is formed in the end portion 13 of the rod 10 for forming or defining two spring fingers 15 and for clamping or gripping the nails 20 between the spring fingers 15. As shown in the right portion of the rod 10 in FIG. 2, two slots 14 are formed in the end portion 13 of the rod 10 and intersecting or communicating with each other for forming or defining four spring fingers 15 and for clamping or gripping the nails 20 between the spring fingers 15. The end portions 13 of the rod 10 may further include one or more channels 19 formed therein and communicating with the slots 14, and arranged in a direction perpendicular to the slots 14 or the spring legs 15 of the rod 10, for laterally receiving and holding the nails 20, best shown in FIGS. 4-6. The end portions 13 of the rod 10 may each include one or more channels 19 formed therein for receiving nails of different diameters.

The end portions 13 of the rod 10 may each include one or more peripheral groove 17 formed in the outer peripheral portion thereof. One or more rubber or resilient rings 21 may be engaged onto the end portions 13 of the rod 10 and may be engaged or received in the peripheral grooves 17 of the end portions 13 of the rod 10 for further applying a resilience against the spring legs 15 and for further biasing the spring legs 15 to grasp or hold the nails 20. It is to be noted that, without the rubber or spring rings 21, the spring legs 15 may also include a suitable resilience for clamping or grasping the nails 20 between the spring legs 15.

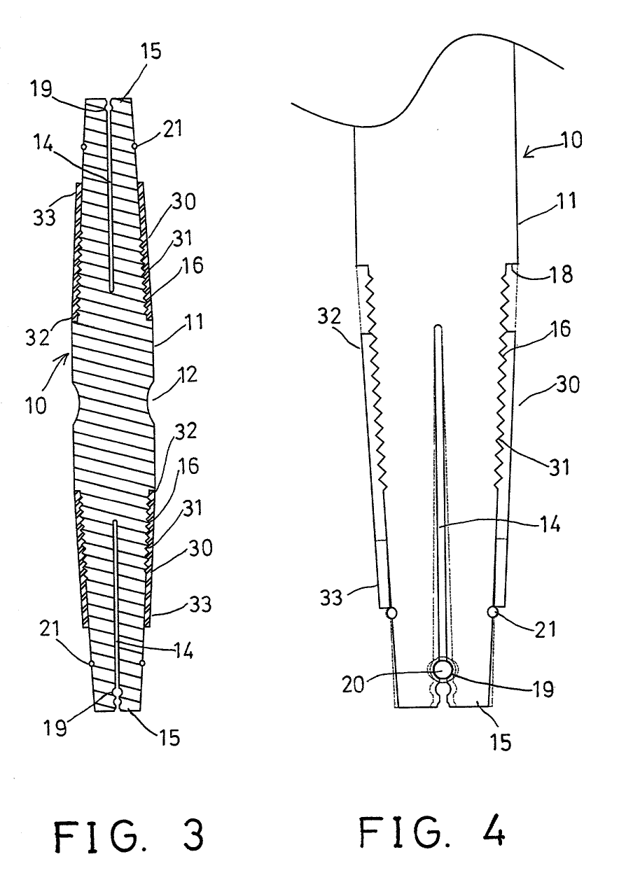

The end portions 13 of the rod 10 each includes an outer thread 16 formed in the outer peripheral portion thereof. A barrel 30 includes an inner thread 31 formed therein for threading with the outer thread 16 of each of the end portions 13 of the rod 10, and for allowing the barrel 30 to be moved or adjusted relative to the end portions 13 of the rod 10 respectively by threading or rotating the barrels 30 relative to the rod 10. The barrel 30 includes one end 32 for engaging with the peripheral shoulder 18 of the rod 10 (FIG. 3), and having a greater diameter than that of the other end 33 which may engage with the resilient ring 21 for limiting the relative movement between the barrel 30 and the rod 10 and for preventing the barrel 30 from being disengaged from the rod 10. When the barrel 30 is moved or adjusted away from the handle 11 or toward the ring 21 (FIG. 4), the smaller end 33 of the barrel 30 may force the spring legs 15 of the rod 10 toward each other, in order to solidly secure and grasp and hold the nail 20 within either of the channels 19 of the rod 10.

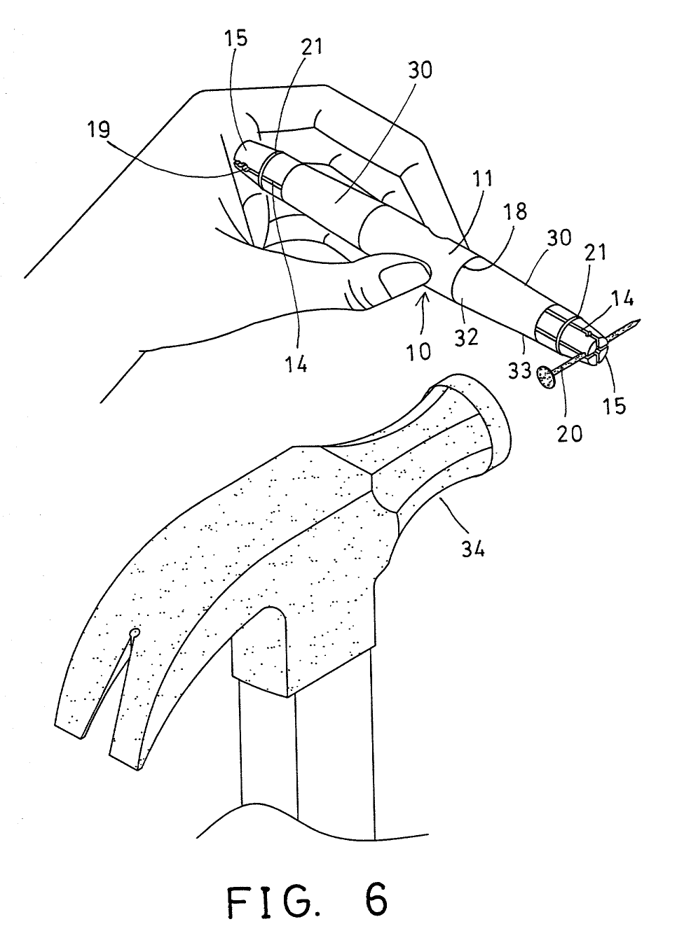

In operation, as shown in FIG. 5, the barrel 30 is moved toward and to engage with the handle 11, for allowing the spring legs 15 to be moved away from each other, and for allowing the nail 20 to be forced into either of the slots 14 and/or either of the channels 19 of the rod, against the resilience of the spring legs 15 themselves, or of the spring ring 21. After the nails 20 have been moved inward of the channels 19 of the rod 10, the barrel 30 may be moved or adjusted toward the ring 21 (FIG. 4) for further forcing the spring legs 15 toward each other to solidly grasp or grip or hold the nails 20 in the channels 19 of the rod 10. As shown in FIG. 6, when the nail 20 is held by the rod 10, the nail 20 may be easily and safely hammered by the hammer 34, and the hand of the users will have no chance to be hammered or hurt by the hammer 34.

Accordingly, the gripping device in accordance with the present invention may be used for safely holding or gripping or obtaining the nails without contacting the hands of the users with the nails, and for firmly holding or gripping the nails without forcing the gripping device all the time while gripping the nails, and for safely holding the nails while hammering the nails.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A gripping device for holding nails, said gripping device comprising:
a rod including a first end having a first slot formed therein for forming a pair of spring legs in said first end of said rod, and for clamping and grasping the nail in said first slot of said rod and between said pair of spring legs.

2. The gripping device according to claim 1, wherein said rod includes at least one channel formed in said first end thereof and communicating with said first slot of said rod for receiving the nail.

3. The gripping device according to claim 1, wherein said rod includes a second slot formed in said first end thereof and communicating and intersecting with said first slot of said rod for forming two pairs of spring legs in said first end of said rod, and for clamping and grasping the nail in either of said first slot or said second slot of said rod.

4. The gripping device according to claim 3, wherein said rod includes at least one channel formed in said first end thereof and communicating with said second slot of said rod for receiving the nail.

5. The gripping device according to claim 1 further comprising means for biasing said pair of spring legs to clamp the nail.

6. The gripping device according to claim 5, wherein said biasing means includes a resilient ring engaged onto said pair of spring legs for biasing said pair of spring legs to clamp the nail.

7. The gripping device according to claim 6, wherein said rod includes a peripheral groove formed in said first end thereof for receiving said resilient ring.

8. The gripping device according to claim 1 further comprising means for forcing said pair of spring legs to clamp the nail.

9. The gripping device according to claim 8, wherein said forcing means includes a barrel threaded onto said pair of spring legs, said barrel includes a first end having a greater diameter and a second end having a smaller diameter for forcing said pair of spring legs toward each other to clamp the nail when said barrel is adjusted and threaded relative to said pair of spring legs.

10. The gripping device according to claim 9 further comprising means for limiting said barrel to move relative to said rod and said spring legs.

11. The gripping device according to claim 10, wherein said limiting means includes a peripheral shoulder formed in said rod for engaging with said barrel and for limiting said barrel to move relative to said rod and said spring legs.
